(19) United States
(12) Patent Application Publication
(10) Pub. No.: US 2015/0220141 A1
(43) Pub. Date: Aug. 6, 2015

(54) COMPUTING SYSTEMS, PERIPHERAL DEVICES AND METHODS FOR CONTROLLING A PERIPHERAL DEVICE

(71) Applicant: Thomas Alexander SHOWS, Leander, TX (US)

(72) Inventor: Thomas Alexander Shows, Leander, TX (US)

(21) Appl. No.: 14/429,261

(22) PCT Filed: Sep. 18, 2012
(86) PCT No.: PCT/US2012/055833

§ 371 Date: Mar. 18, 2015

(51) Int. Cl. G06F 3/00; G06F 3/041; G06F 3/02

(52) U.S. Cl. CPC G06F 3/005; G06F 3/0202; G06F 3/0412; G09G 2340/02

(57) ABSTRACT

According to various embodiments, a computing system may be provided. The computing system may include: a host computer, and a peripheral device. The host computer may include: an input interface configured to receive an input from an external device; and a video output configured to output video data. The peripheral device may include: a mechanical input part configured to receive mechanical input from a user of the host computer; an output interface to the host computer configured to send data representing the mechanical input to the input interface of the host computer; a video input configured to receive video data from the video output of the host computer; and a video encoding circuit configured to compress the video data using a video encoder.

### TECHNICAL FIELD

Various embodiments generally relate to computing systems, peripheral devices and methods for controlling a peripheral device.

### BACKGROUND

Users of computers, for example PC (personal computer) users, for example gamers, may depend greatly on the information presented to them by one or more displays in the system. As events may occur in real-time on the screen, it may be difficult to take in all the information immediately, and when certain events occur, such as catastrophic failures in the attempt to achieve some goal, the player may be left to sort through log files to determine the failure mode and contributing factors.

PC users may employ host-based software to record the video being sent to the display, which may then be reviewed outside of the game at a later time. Furthermore, PC games may incorporate methods of recording gameplay which may be reviewed after the completion of a game session.

The various methods of reviewing past events may have drawbacks, for example the performance impact to the host PC to record and encode video concurrently while the game is executing. This concurrency of host-based recording may limit game performance by sapping resources that would otherwise be available for the game to utilize, such as CPU (central processing unit) and GPU (graphics processing unit) computational cycles, as well as memory and storage, and the bandwidth required to access these subsystems.

Therefore, it may be beneficial to the user if they could run their application to the fullest performance afforded by the host system, while retaining the ability to record the video of the application execution.

Furthermore, it may be beneficial to the user to be permitted to review past events in an intuitive and easily accessible manner, without exiting the application or changing the focus from the application (such as a game) to view and manipulate a separate video recording and playback application.

### SUMMARY OF THE INVENTION

According to various embodiments, a computing system may be provided. The computing system may include: a host computer and a peripheral device. The host computer may include: an input interface configured to receive an input from an external device; and a video output configured to output video data. The peripheral device may include: a mechanical input part configured to receive mechanical input from a user of the host computer; an output interface to the host computer configured to send data representing the mechanical input to the input interface of the host computer; a video input configured to receive video data from the video output of the host computer; and a video encoding circuit configured to compress the video data using a video encoder.

According to various embodiments, a peripheral device for a computing system may be provided. The computing system may include: a host computer, and the peripheral device. The host computer may include: an input interface configured to receive an input from an external device; and a video output configured to output video data. The peripheral device may include: a mechanical input part configured to receive mechanical input from a user of the host computer; an output interface to the host computer configured to send data representing the mechanical input to the input interface of the host computer; a video input configured to receive video data from the video output of the host computer; and a video encoding circuit configured to compress the video data using a video encoder.

According to various embodiments, a peripheral device for a host computer may be provided. The peripheral device may include: a mechanical input part configured to receive mechanical input from a user of the host computer; an output interface to the host computer configured to send data representing the mechanical input to the host computer; a video input configured to receive video data from the host computer; and a video encoding circuit configured to compress the video data using a video encoder.

According to various embodiments, a computing system may be provided. The computing system may include: a host computer, a monitor; and a peripheral device. The host computer may include: an input interface configured to receive an input from an external device; and an image raw data output configured to output image raw data for an image to be rendered. The peripheral device may include: a mechanical input part configured to receive mechanical input from a user of the host computer; an output interface to the host computer configured to send data representing the mechanical input to the input interface of the host computer; an image raw data input configured to receive image raw data from the image raw data output of the host computer; a graphics processing circuit configured to compute pixel values of the image to be rendered based on the received image raw data; and a video output configured to output the computed pixel values to the display.

According to various embodiments, a peripheral device for a computing system may be provided. The computing system may include: a host computer, a monitor, and a peripheral device. The host computer may include: an input interface configured to receive an input from an external device; and an image raw data output configured to output image raw data for an image to be rendered. The peripheral device may include: a mechanical input part configured to receive mechanical input from a user of the host computer; an output interface to the host computer configured to send data representing the mechanical input to the input interface of the host computer; an image raw data input configured to receive image raw data from the image raw data output of the host computer; a graphics processing circuit configured to compute pixel values of the image to be rendered based on the received image raw data; and a video output configured to output the computed pixel values to the display.

According to various embodiments, a peripheral device for a host computer may be provided. The peripheral device may include: a mechanical input part configured to receive mechanical input from a user of the host computer; an output interface to the host computer configured to send data representing the mechanical input to the host computer; an image raw data input configured to receive image raw data for an image to be rendered from the host computer; a graphics processing circuit configured to compute pixel values of the image to be rendered based on the received image raw data; and a video output configured to output the computed pixel values to a display for the host computer.

According to various embodiments, a peripheral device for a host computer may be provided. The peripheral device may include: an input device interface configured to send data to and receive data from a mechanical input device for the host computer; a video input configured to receive video data from the host computer; and a video encoding circuit configured to compress the video data using a video encoder.

According to various embodiments, a peripheral device for a host computer may be provided. The peripheral device may include: an input device interface configured to send data to and receive data from a mechanical input device for the host computer; an image raw data input configured to receive image raw data for an image to be rendered from the host computer; a graphics processing circuit configured to compute pixel values of the image to be rendered based on the received image raw data; and a video output configured to output the computed pixel values to a display for the host computer.

According to various embodiments, a method for controlling a peripheral device for a host computer may be provided. The method may include: receiving mechanical input from a user of the host computer; sending data representing the mechanical input to the host computer; receiving video data from the host computer; and compressing the video data using a video encoder.

According to various embodiments, a method for controlling a peripheral device for a host computer may be provided. The method may include: receiving mechanical input from a user of the host computer; sending data representing the mechanical input to the host computer; receiving image raw data for an image to be rendered from the host computer; computing pixel values of the image to be rendered based on the received image raw data; and outputting the computed pixel values to a display for the host computer.

According to various embodiments, a method for controlling a peripheral device for a host computer may be provided. The method may include: sending data to and receiving data from a mechanical input device for the host computer; receiving video data from the host computer; and compressing the video data using a video encoder.

According to various embodiments, a method for controlling a peripheral device for a host computer may be provided. The method may include: sending data to and receiving data from a mechanical input device for the host computer; receiving image raw data for an image to be rendered from the host computer; computing pixel values of the image to be rendered based on the received image raw data; and outputting the computed pixel values to a display for the host computer.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the invention. The dimensions of the various features or elements may be arbitrarily expanded or reduced for clarity. In the following description, various embodiments of the invention are described with reference to the following drawings, in which:

FIG. 1 shows a computing system with a keyboard;

FIG. 2 shows a computing system with a keyboard with a touch pad;

FIG. 3 shows a computing system in accordance with an embodiment;

FIG. 4 shows a computing system in accordance with an embodiment;

FIG. 5 shows a peripheral device in accordance with an embodiment;

FIG. 6 shows a peripheral device in accordance with an embodiment;

FIG. 7 shows a peripheral device in accordance with an embodiment;

FIG. 8 shows a peripheral device in accordance with an embodiment;

FIG. 9 shows a computing system in accordance with an embodiment;

FIG. 10 shows a peripheral device in accordance with an embodiment;

FIG. 11 shows a peripheral device in accordance with an embodiment;

FIG. 12 shows a peripheral device in accordance with an embodiment;

FIG. 13 shows a peripheral device in accordance with an embodiment;

FIG. 14 shows a peripheral device in accordance with an embodiment;

FIG. 15 shows a peripheral device in accordance with an embodiment;

FIG. 16 shows a flow diagram illustrating a method for controlling a peripheral device in accordance with an embodiment;

FIG. 17 shows a flow diagram illustrating a method for controlling a peripheral device in accordance with an embodiment;

FIG. 18 shows a flow diagram illustrating a method for controlling a peripheral device in accordance with an embodiment;

FIG. 19 shows a flow diagram illustrating a method for controlling a peripheral device in accordance with an embodiment;

FIG. 20 shows a computing system in accordance with an embodiment; and

FIG. 21 shows a peripheral device in accordance with an embodiment.

### DETAILED DESCRIPTION

The following detailed description refers to the accompanying drawings that show, by way of illustration, specific details and embodiments in which the invention may be practiced. These embodiments are described in sufficient detail to enable those skilled in the art to practice the invention. Other embodiments may be utilized and structural, and logical changes may be made without departing from the scope of the invention. The various embodiments are not necessarily mutually exclusive, as some embodiments can be combined with one or more other embodiments to form new embodiments.

In order that the invention may be readily understood and put into practical effect, particular embodiments will now be described by way of examples and not limitations, and with reference to the figures.

The peripheral device may comprise a memory which is for example used in the processing carried out by the peripheral device. A memory used in the embodiments may be a volatile memory, for example a DRAM (Dynamic Random Access Memory) or a non-volatile memory, for example a PROM (Programmable Read Only Memory), an EPROM (Erasable PROM), EEPROM (Electrically Erasable PROM), or a flash memory, e.g., a floating gate memory, a charge trapping memory, an MRAM (Magnetoresistive Random Access Memory) or a PCRAM (Phase Change Random Access Memory).

In an embodiment, a “circuit” may be understood as any kind of a logic implementing entity, which may be special purpose circuitry or a processor executing software stored in a memory, firmware, or any combination thereof. Thus, in an embodiment, a “circuit” may be a hard-wired logic circuit or a programmable logic circuit such as a programmable processor, e.g. a microprocessor (e.g. a Complex Instruction Set Computer (CISC) processor or a Reduced Instruction Set Computer (RISC) processor). A “circuit” may also be a processor executing software, e.g. any kind of computer program, e.g. a computer program using a virtual machine code such as e.g. Java. Any other kind of implementation of the respective functions which will be described in more detail below may also be understood as a “circuit” in accordance with an alternative embodiment. It will be understood that what is described herein as circuits with different names (for example “circuit A” and “circuit B”) may also be provided in one physical circuit like described above.

Various embodiments are provided for devices, and various embodiments are provided for methods. It will be understood that basic properties of the devices also hold for the methods and vice versa. Therefore, for sake of brevity, duplicate description of such properties may be omitted.

It will be understood that any property described herein for a specific device may also hold for any device described herein. It will be understood that any property described herein for a specific method may also hold for any method described herein. Furthermore, it will be understand that for any device or method described herein, not necessarily all the components or steps described must be enclosed in the device or method, but only some (but not all) components or steps may be enclosed.

Low power system-on-chip (SoC) technology has advanced significantly with the introduction of smartphones. The latest SoC's may be capable not only of handling complex video processing tasks, such as encode and decode, they often may incorporate dedicated operating systems such as Android and Linux to control the various subsystems much like larger personal computer systems. These SoC's may be employed in the user of digital video recorder/personal video recorder systems (DVR/PVR) for the purpose of recording and playing back video.

According to various embodiments, devices and methods may be provided for the integration of video recording capabilities into a keyboard, enabling PC users to “time shift” backward to view previous events, and for other purposes. The computational and networking capabilities of these SoC devices may also be leveraged for streaming video content in a way that is independent of the host PC, as to not burden the host with such computationally-intensive tasks.

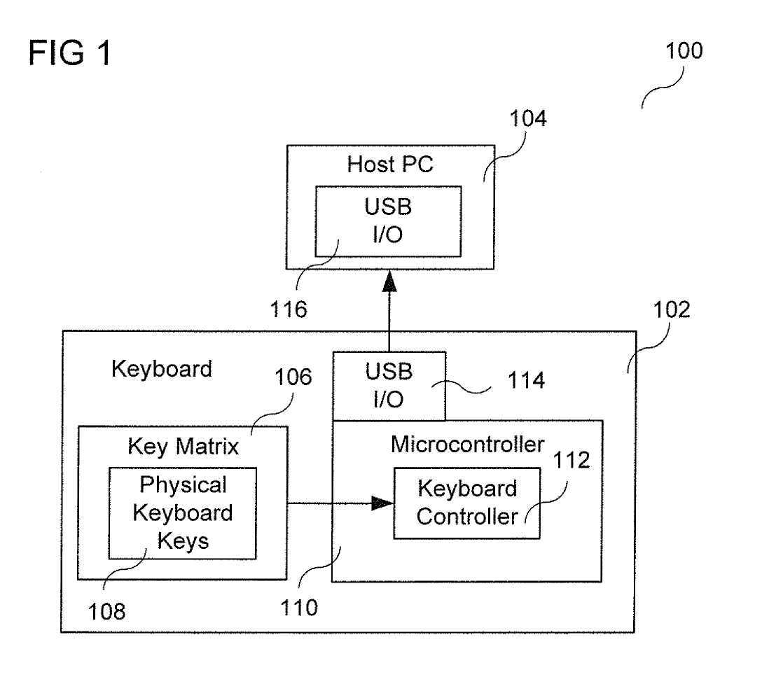

FIG. 1 shows a computing system 100 with a keyboard 102. The computing system 100 may further include a host computer 104 (for example a host personal computer (PC)). The host computer 104 may include a USB (universal serial bus) input-output (I/O) circuit 116. The keyboard 102 may include a microcontroller 110 which may read a key matrix 106 (which may include physical keyboard keys 108). The key matrix 106 may report the state of the physical keyboard keys 108 to a keyboard controller 112 in the microcontroller 110. The microcontroller 112 may send this information to the host computer 104 via a USB I/O 114 in the keyboard and the USB I/O 116 of the host computer.

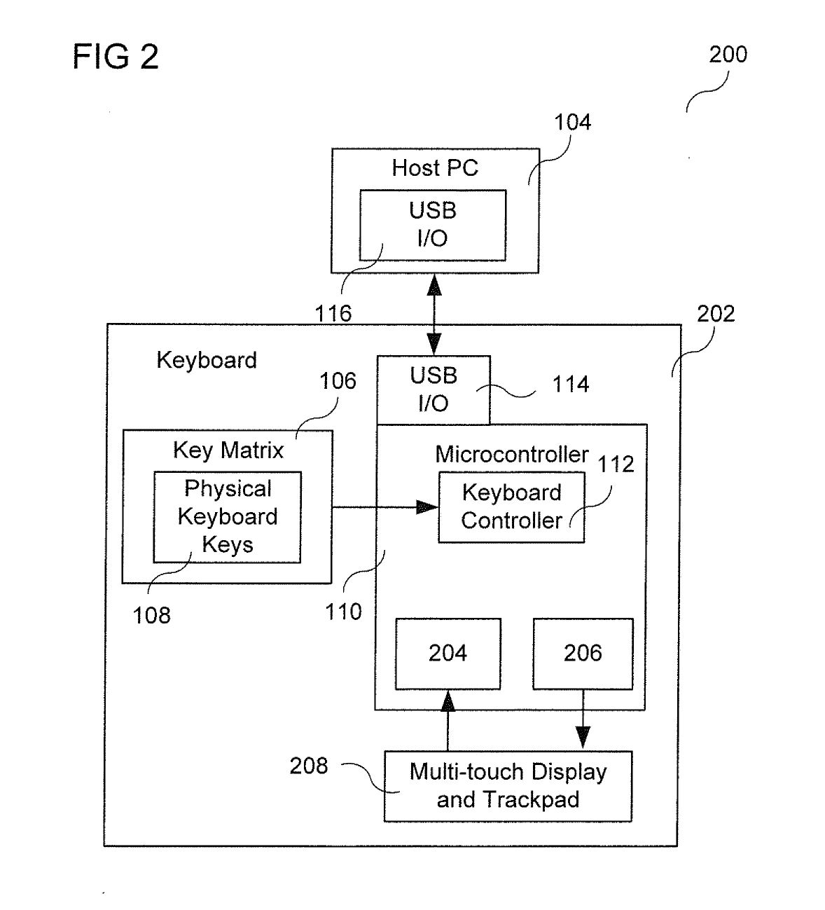

FIG. 2 shows a computing system 200 with a keyboard 202 with a touch pad (for example a multi-touch display and trackpad 206). The computing system 200 may, similar to the computing system 100 of FIG. 1, further include a host computer 104. The host computer 104 may, similar to the host computer 104 of FIG. 1, include a USB I/O 116. The keyboard 202 may, similar to the keyboard 102 of FIG. 1, include a key matrix 106 with physical keyboard keys 108, and a microcontroller 110 with a keyboard controller 112. The keyboard 202 may, similar to the keyboard 102 of FIG. 1, further include an USB I/O 114. The microcontroller 110 may further include a trackpad controller 204 and a integrated display controller 206. The keyboard 202 may include a multi-touch display 208 as a trackpad. The USB link may function bidirectionally, sending image data down from the host computer 104 to the display 208 and the keyboard 202 may report touch data as cursor movement, among other usages, to the host computer 104.

PC users may require a separate, often expensive component such as a digital video recorder, and the appropriate software to drive it, in order to record application execution and play it back. Digital video recording systems for games may not be designed for local video recording and playback using keyboard-based controls.

Some games may support time shifting as part of the gameplay, but this may not universally be supported, and often may include caveats such as requiring completion of goals, or in some cases failure to complete goals (for example rewind and view events leading up to a crash in a racing game).

Another method of recording application execution (for example a game) may require software executed on the host, which may burden the host and may sap resources that would otherwise be available to the game to increase performance.

According to various embodiments, a video recording keyboard may be provided.

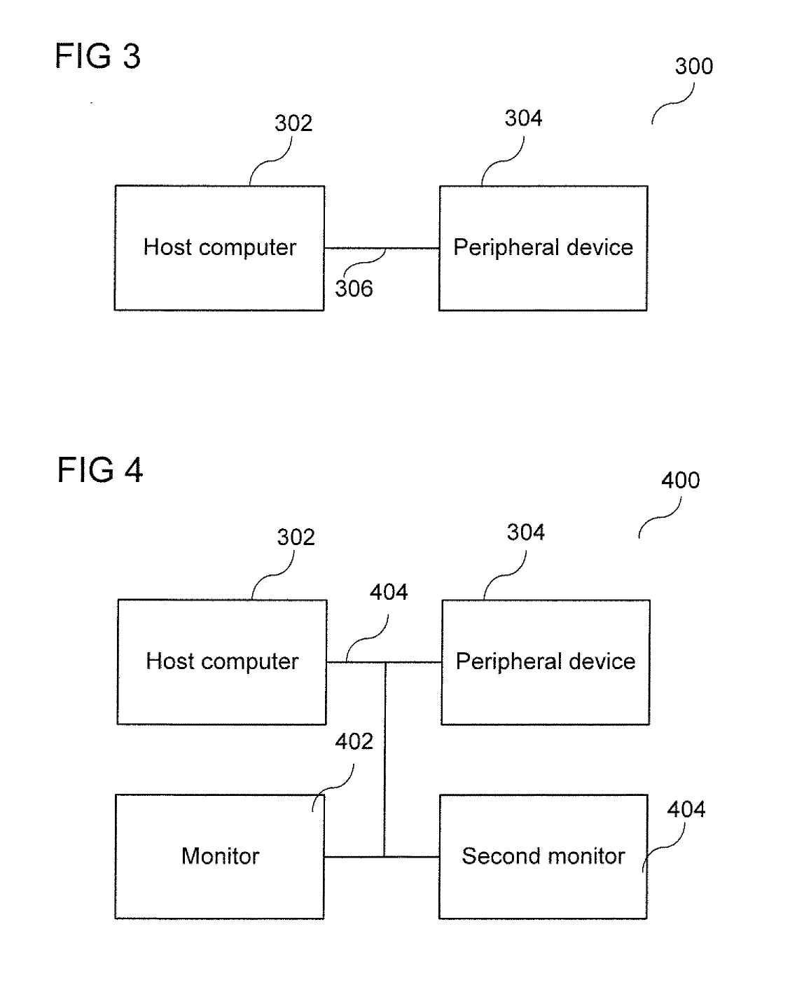

FIG. 3 shows a computing system 300 in accordance with an embodiment. The computing system 300 may include: a host computer 302 and a peripheral device 304. The host computer 302 and the peripheral device 304 may be connected via a connection 306 (or a plurality of separate connections), for example an electrical or optical connection, for example any kind of cable or bus. The host computer 302 may include: an input interface configured to receive an input from an external device; and a video output configured to output video data. The peripheral device 304 may include: a mechanical input part configured to receive mechanical input from a user of the host computer 302; an output interface to the host computer 302 configured to send data representing the mechanical input to the input interface of the host computer 302; a video input configured to receive video data from the video output of the host computer 302; and a video encoding circuit configured to compress the video data using a video encoder.

According to various embodiments, the peripheral device 304 may further include a housing (in other words: the components of the peripheral device 304 may be provided inside a housing).

According to various embodiments, the host computer 302 may further include a housing (in other words: the components of the host computer 302 may be provided inside a housing), wherein the housing of the peripheral device 304 may be different from the housing of the host computer 302.

According to various embodiments, the mechanical input part of the peripheral device 304 may include or may be at least one of: a keyboard; a racing steering wheel; a flight controller; an arcade stick; a mouse; a joystick; a keypad; and a Razer Artemis.

According to various embodiments, the output interface of the peripheral device 304 may be configured according to at least one of: Universal Serial Bus (USB); PS/2; Advanced Technology (AT); Firewire; Thunderbolt; and Wireless Gigabit Alliance (WiGig).

According to various embodiments, the output interface of the peripheral device 304 and the video input interface of the peripheral device 304 may be a combined interface.

According to various embodiments, the peripheral device 304 may further be configured to receive data for controlling the video encoding circuit of the peripheral device 304 from the host computer 302.

According to various embodiments, the data for controlling the video encoding circuit of the peripheral device 304 may include or may be information indicating when processing of the video encoding circuit is to be started.

According to various embodiments, the peripheral device 304 may further include a video recording circuit configured to record (for example to a storage internal to the peripheral device 304 or external to the peripheral device 304) at least one of the received video data and the compressed video data.

According to various embodiments, the peripheral device 304 may further include a video sending circuit configured to send (for example wirelessly, for example via the internet, for example to another player of a computer game presently played on the host computer 302) at least one of the received video data and the compressed video data.

According to various embodiments, the peripheral device 304 may further include a video playing circuit configured to play (in other words: replay or play back) a video, for example a previously recorded video, for example a video recorded from the received video data.

According to various embodiments, the peripheral device 304 may further include a display.

According to various embodiments, the display of the peripheral device 304 may be configured to display the video data.

According to various embodiments, the display of the peripheral device 304 may include or may be a touch sensitive display.

According to various embodiments, the touch sensitive display of the peripheral device 304 may include a multi touch display.

According to various embodiments, the touch sensitive display of the peripheral device 304 may be configured to provide control elements for controlling the video encoding circuit.

According to various embodiments, the peripheral device 304 may further include an input controller configured to control the output interface of the peripheral device 304 based on the received mechanical input.

According to various embodiments, the peripheral device 304 may further include a system on a chip (SoC).

According to various embodiments, the system on a chip of the peripheral device 304 may include the input controller.

According to various embodiments, the system on a chip of the peripheral device 304 may include any one of the circuits of the peripheral device 304.

According to various embodiments, the system on a chip of the peripheral device 304 may include the video encoding circuit of the peripheral device 304.

According to various embodiments, the peripheral device 304 may further include a digital media recording chip.

According to various embodiments, the digital media recording chip of the peripheral device 304 may include or may be the video encoding circuit of the peripheral device 304.

According to various embodiments, the peripheral device 304 may further include a video processing controlling element configured to receive a user input for controlling of processing of the video encoding circuit of the peripheral device 304.

According to various embodiments, the video processing controlling element of the peripheral device 304 may include or may be at least one of a key and a touch display.

According to various embodiments, the output interface of the peripheral device 304 may further be configured to send data representing a mechanical input command to the host computer 302 based on the received user input of the video processing controlling element of the peripheral device 304.

According to various embodiments, the data representing a mechanical input command based on the received user input of the video processing controlling element of the peripheral device 304 may include or may be data representing an instruction for pausing an application of the host computer 302.

According to various embodiments, the peripheral device 304 may further include a video output.

According to various embodiments, the video output of the peripheral device 304 may be configured to output video data based on recorded video data.

FIG. 4 shows a computing system 400 in accordance with an embodiment. The computing system 400 may, similar to the computing system 300 of FIG. 3, include the host computer 302 of FIG. 3. The computing system 400 may, similar to the computing system 300 of FIG. 3, further include the peripheral device 304 of FIG. 3. The computing system 400 may further include a monitor 402, like will be described below. The computing system 400 may further include a second monitor 404, like will be described below.

According to various embodiments, the video output of the peripheral device 304 may be configured to display the video data on the monitor 402.

According to various embodiments, the video output of the peripheral device 304 may be configured to display the video data on the monitor 402 in full screen mode.

According to various embodiments, the video output of the peripheral device 304 may be configured to display the video data on the monitor 402 in a window smaller than a maximum monitor display size.

According to various embodiments, the monitor 402 (which may also be referred to as a first monitor 402) may be connected to the host computer 302, and the second monitor 404 may be connected to the video output of the peripheral device 304.

According to various embodiments, the host computer 302 may further include a first video output and a second video output, wherein each of first video output of the host computer 302 and the second video output of the host computer 302 may be configured to be connected to a monitor. According to various embodiments, the first video output of the host computer 302 may be connected to the video input of the peripheral device 304, and the second video output of the host computer 302 may be connected to the monitor 402.

According to various embodiments, the peripheral device 304 may further include a video output configured to output video data, wherein the video output of the peripheral device 304 may be connected to the second monitor 404.

According to various embodiments, the peripheral device 304 may be an external peripheral device.

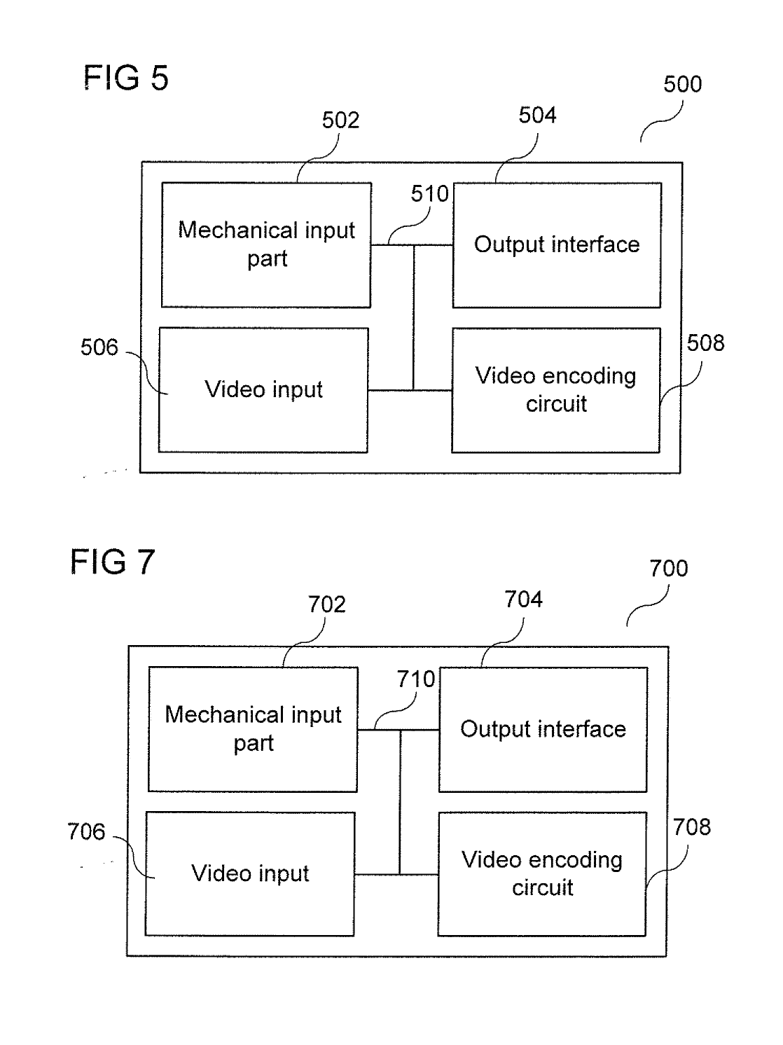

FIG. 5 shows a peripheral device 500 for a computing system in accordance with an embodiment. The computing system may include: a host computer and the peripheral device. The host computer may include: an input interface configured to receive an input from an external device; and a video output configured to output video data. The peripheral device 500 may include: a mechanical input part 502 configured to receive mechanical input from a user of the host computer; an output interface 504 to the host computer configured to send data representing the mechanical input to the input interface of the host computer; a video input 506 configured to receive video data from the video output of the host computer; and a video encoding circuit 508 configured to compress the video data using a video encoder. The mechanical input part 502, the output interface 504, the video input 506, and the video encoding circuit 508 may be connected via a connection 510 (or a plurality of separate connections), for example an electrical or optical connection, for example any kind of cable or bus.

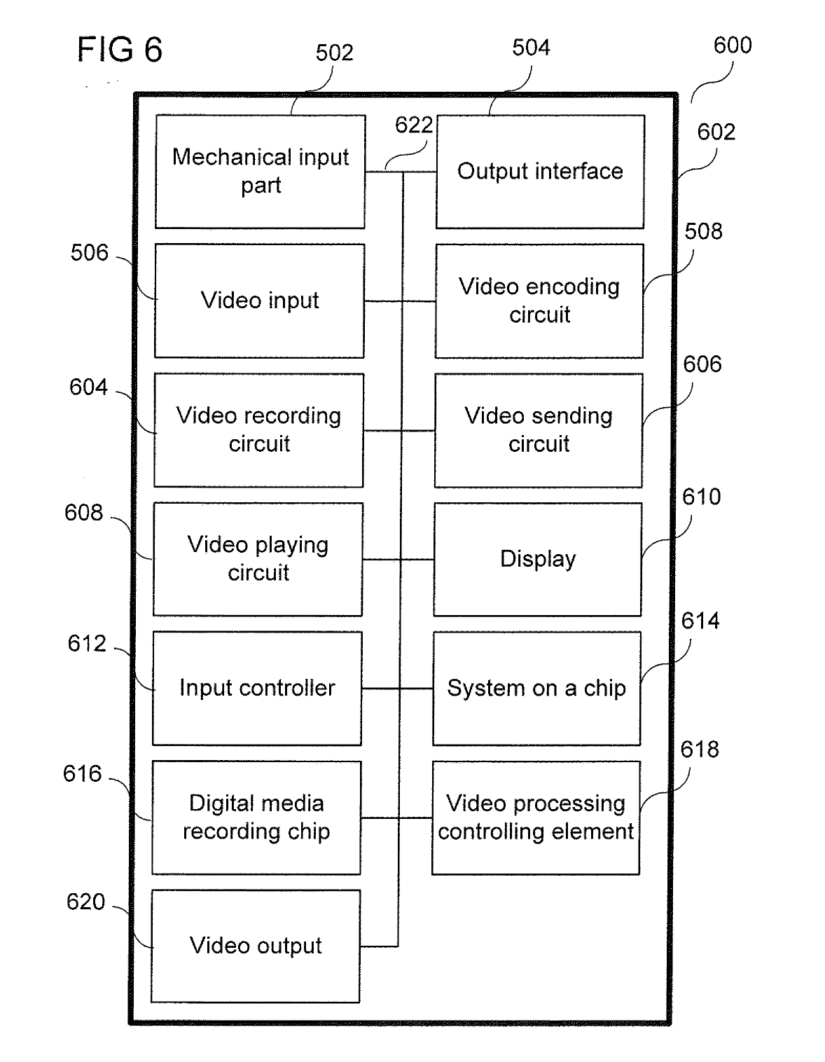

FIG. 6 shows a peripheral device 600 for a computing system in accordance with an embodiment. The computing system may include: a host computer and the peripheral device. The host computer may include: an input interface configured to receive an input from an external device; and a video output configured to output video data. The peripheral device 600 may, similar to the peripheral device 500 of FIG. 5, include a mechanical input part 502 configured to receive mechanical input from a user of the host computer. The peripheral device 600 may, similar to the peripheral device 500 of FIG. 5, include an output interface 504 to the host computer configured to send data representing the mechanical input to the input interface of the host computer. The peripheral device 600 may, similar to the peripheral device 500 of FIG. 5, include a video input 506 configured to receive video data from the video output of the host computer. The peripheral device 600 may, similar to the peripheral device 500 of FIG. 5, include a video encoding circuit 508 configured to compress the video data using a video encoder. The peripheral device 600 may further include a video recording circuit 604, like described in more detail below. The peripheral device 600 may further include a video sending circuit 606, like described in more detail below. The peripheral device 600 may further include a video playing circuit 608, like described in more detail below. The peripheral device 600 may further include a display 610, like described in more detail below. The peripheral device 600 may further include an input controller 612, like described in more detail below. The peripheral device 600 may further include a system on a chip 614, like described in more detail below. The peripheral device 600 may further include a digital media recording chip 616, like described in more detail below. The peripheral device 600 may further include a video processing controlling element 618, like described in more detail below. The peripheral device 600 may further include a video output 620, like described in more detail below. The mechanical input part 502, the output interface 504, the video input 506, the video encoding circuit 508, the video recording circuit 604, the video sending circuit 606, the video playing circuit 608, the display 610, the input controller 612, the system on a chip 614, the digital media recording chip 616, the video processing controlling element 618, and the video output 620, may be connected via a connection 622 (or a plurality of separate connections), for example an electrical or optical connection, for example any kind of cable or bus.

According to various embodiments, the peripheral device 600 may include a housing 602, like indicated by a bold lined box in FIG. 6. In other words: the components of the peripheral device 600 may be provided inside the housing 602.

According to various embodiments, the host computer of the computing system may further include a housing (in other words: the components of the host computer may be provided inside a housing). According to various embodiments, the housing 602 of the peripheral device 600 may be different from the housing of the host computer.

According to various embodiments, the mechanical input part 502 may include or may be at least one of: a keyboard; a racing steering wheel; a flight controller; an arcade stick; a mouse; a joystick; a keypad; and a Razer Artemis.

According to various embodiments, the output interface 504 may be configured according to at least one of: Universal Serial Bus (USB); PS/2; Advanced Technology (AT); Firewire; Thunderbolt; and Wireless Gigabit Alliance (WiGig).

According to various embodiments, the output interface 504 and the video input 506 may be a combined interface.

According to various embodiments, the peripheral device 600 may further be configured to receive data for controlling the video encoding circuit 508 from the host computer.

According to various embodiments, the data for controlling the video encoding circuit 508 may include or may be information indicating when processing of the video encoding circuit 508 is to be started.

According to various embodiments, the video recording circuit 604 may be configured to record (for example to a storage internal to the peripheral device 600 or external to the peripheral device 600) at least one of the received video data and the compressed video data.

According to various embodiments, the video sending circuit 606 may be configured to send (for example wirelessly, for example via the internet, for example to another player of a computer game presently played on the host computer) at least one of the received video data and the compressed video data.

According to various embodiments, the video playing circuit 608 may be configured to play (in other words: replay or play back) a video, for example a previously recorded video, for example a video recorded from the received video data.

According to various embodiments, the display 610 may be configured to display the video data.

According to various embodiments, the display 610 may include or may be a touch sensitive display.

According to various embodiments, the touch sensitive display may include or may be a multi touch display.

According to various embodiments, the touch sensitive display may be configured to provide control elements for controlling the video encoding circuit 508.

According to various embodiments, the input controller 612 may be configured to control the output interface based on the received mechanical input.

According to various embodiments, the system on a chip 614 may include the input controller 612.

According to various embodiments, the system on a chip 614 may include any one of the circuits of the peripheral device 600.

According to various embodiments, the system on a chip 614 may include the video encoding circuit 508.

According to various embodiments, the digital media recording chip 616 may include or may be the video encoding circuit 508.

According to various embodiments, the video processing controlling element 618 may be configured to receive a user input for controlling of processing of the video encoding circuit 508.

According to various embodiments, the video processing controlling element 618 may include or may be at least one of a key and a touch display.

According to various embodiments, the output interface 504 may be further configured to send data representing a mechanical input command to the host computer based on the received user input of the video processing controlling element 618.

According to various embodiments, the data representing a mechanical input command based on the received user input of the video processing controlling element 618 may include or may be data representing an instruction for pausing an application of the host computer.

According to various embodiments, the video output 620 may be configured to output video data based on recorded video data.

According to various embodiments, the computing system further may include a monitor.

According to various embodiments, the video output 620 may be configured to display the video data on the monitor.

According to various embodiments, the video output 620 may be configured to display the video data on the monitor in full screen mode.

According to various embodiments, the video output 620 may be configured to display the video data on the monitor in a window smaller than a maximum monitor display size.

According to various embodiments, the computing system may further include a first monitor and a second monitor, wherein the first monitor may be connected to the host computer; and wherein the second monitor may be connected to the video output 620 of the peripheral device 600.

According to various embodiments, the host computer may further include a first video output and a second video output, wherein each of first video output of the host computer and the second video output of the host computer may be configured to be connected to a monitor. According to various embodiments, the first video output of the host computer may be connected to the video input 506 of the peripheral device 600, and the second video output of the host computer may be connected to the monitor.

According to various embodiments, the computing system may further include a second monitor. According to various embodiments, the video output 620 of the peripheral device may be connected to the second monitor.

According to various embodiments, the peripheral device may be an external peripheral device.

FIG. 7 shows a peripheral device 700 for a host computer in accordance with an embodiment. The peripheral device 700 may include: a mechanical input part 702 configured to receive mechanical input from a user of the host computer; an output interface 704 to the host computer configured to send data representing the mechanical input to the host computer; a video input 706 configured to receive video data from the host computer; and a video encoding circuit 708 configured to compress the video data using a video encoder. The mechanical input part 702, the output interface 704, the video input 706, and the video encoding circuit 708 may be connected via a connection 710 (or a plurality of separate connections), for example an electrical or optical connection, for example any kind of cable or bus.

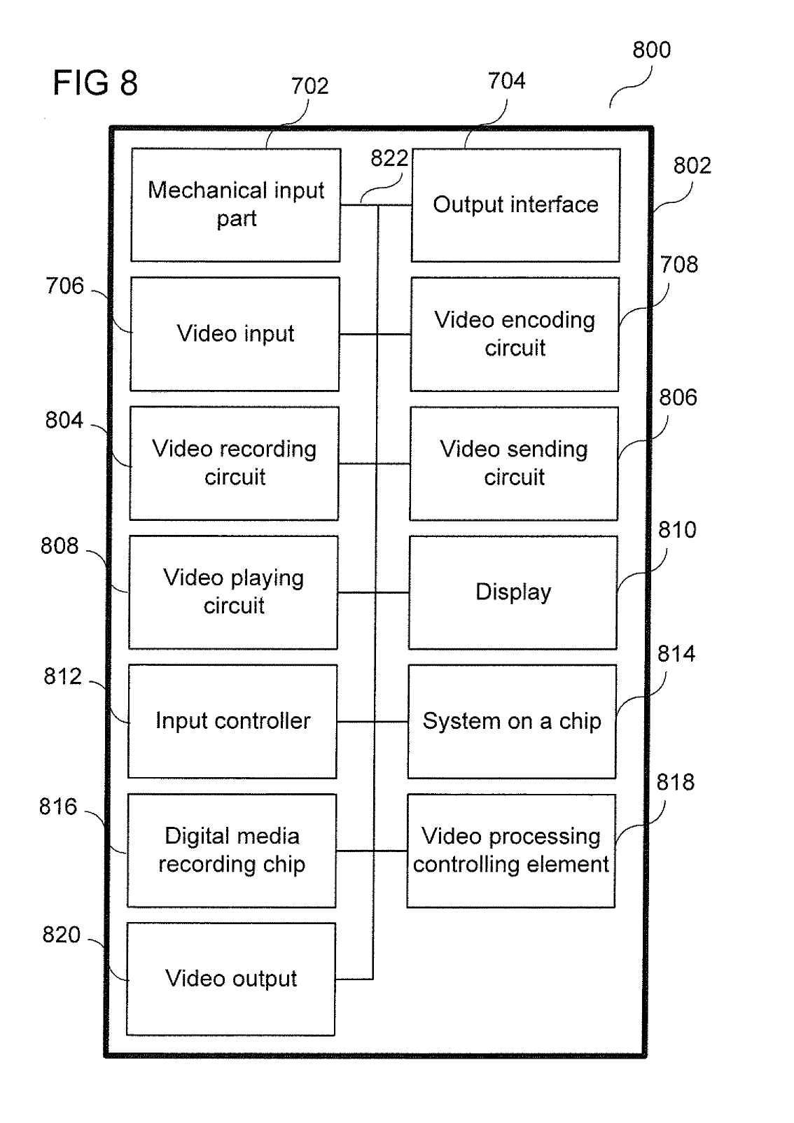

FIG. 8 shows a peripheral device 800 for a host computer in accordance with an embodiment. The peripheral device 800 may, similar to the peripheral device 700 of FIG. 7, include a mechanical input part 702 configured to receive mechanical input from a user of the host computer. The peripheral device 800 may, similar to the peripheral device 700 of FIG. 7, further include an output interface 704 to the host computer configured to send data representing the mechanical input to the host computer. The peripheral device 800 may, similar to the peripheral device 700 of FIG. 7, further include a video input 706 configured to receive video data from the host computer. The peripheral device 800 may, similar to the peripheral device 700 of FIG. 7, further include a video encoding circuit 708 configured to compress the video data using a video encoder. The peripheral device 800 may further include a video recording circuit 804, like described in more detail below. The peripheral device 800 may further include a video sending circuit 806, like described in more detail below. The peripheral device 800 may further include a video playing circuit 808, like described in more detail below. The peripheral device 800 may further include a display 810, like described in more detail below. The peripheral device 800 may further include an input controller 812, like described in more detail below. The peripheral device 800 may further include a system on a chip 814, like described in more detail below. The peripheral device 800 may further include a digital media recording chip 816, like described in more detail below. The peripheral device 800 may further include a video processing controlling element 818, like described in more detail below. The peripheral device 800 may further include a video output 820, like described in more detail below. The mechanical input part 702, the output interface 704, the video input 706, the video encoding circuit 708, the video recording circuit 804, the video sending circuit 806, the video playing circuit 808, the display 810, the input controller 812, the system on a chip 814, the digital media recording chip 816, the video processing controlling element 818, and the video output 820, may be connected via a connection 822 (or a plurality of separate connections), for example an electrical or optical connection, for example any kind of cable or bus.

According to various embodiments, the peripheral device 800 may include a housing 802, like indicated by a bold lined box in FIG. 8. In other words: the components of the peripheral device 800 may be provided inside the housing 802.

According to various embodiments, the housing 802 of the peripheral device 800 may be different from a housing of the host computer.

According to various embodiments, the mechanical input part 702 may include or may be at least one of: a keyboard; a racing steering wheel; a flight controller; an arcade stick; a mouse; a joystick; a keypad; and a Razer Artemis.

According to various embodiments, the output interface 704 may be configured according to at least one of: Universal Serial Bus (USB); PS/2; Advanced Technology (AT); Firewire; Thunderbolt; and Wireless Gigabit Alliance (WiGig).

According to various embodiments, the output interface 704 and the video input 706 may be a combined interface.

According to various embodiments, the peripheral device 800 may further be configured to receive data for controlling the video encoding circuit 708 from the host computer.

According to various embodiments, the data for controlling the video encoding circuit 708 may include or may be information indicating when processing of the video encoding circuit 708 is to be started.

According to various embodiments, the video recording circuit 804 may be configured to record (for example to a storage internal to the peripheral device 800 or external to the peripheral device 800) at least one of the received video data and the compressed video data.

According to various embodiments, the video sending circuit 806 may be configured to send (for example wirelessly, for example via the internet, for example to another player of a computer game presently played on the host computer) at least one of the received video data and the compressed video data.

According to various embodiments, the video playing circuit 808 may be configured to play (in other words: replay or play back) a video, for example a previously recorded video, for example a video recorded from the received video data.

According to various embodiments, the display 810 may be configured to display the video data.

According to various embodiments, the display 810 may include or may be a touch sensitive display.

According to various embodiments, the touch sensitive display may include or may be a multi touch display.

According to various embodiments, the touch sensitive display may be configured to provide control elements for controlling the video encoding circuit 708.

According to various embodiments, the input controller 812 may be configured to control the output interface 704 based on the received mechanical input.

According to various embodiments, the system on a chip 814 may include the input controller 812.

According to various embodiments, the system on a chip 814 may include any one of the circuits of the peripheral device 800.

According to various embodiments, the system on a chip 814 may include the video encoding circuit 708.

According to various embodiments, the digital media recording chip 818 may include or may be the video encoding circuit 708.

According to various embodiments, the video processing controlling element 818 may be configured to receive a user input for controlling of processing of the video encoding circuit 708.

According to various embodiments, the video processing controlling element 818 may include or may be at least one of a key and a touch display.

According to various embodiments, the output interface 704 may further be configured to send data representing a mechanical input command to the host computer based on the received user input of the video processing controlling element 818.

According to various embodiments, the data representing a mechanical input command based on the received user input of the video processing controlling element 818 may include or may be data representing an instruction for pausing an application of the host computer.

According to various embodiments, the video output 820 may be configured to output video data based on recorded video data.

According to various embodiments, the video output 820 may be configured to display the video data on a monitor.

According to various embodiments, the video output 820 may be configured to display the video data on a monitor in full screen mode.

According to various embodiments, the video output 820 may be configured to display the video data on a monitor in a window smaller than a maximum monitor display size.

According to various embodiments, the monitor may be different from a monitor connected to the host computer.

According to various embodiments, the peripheral device 800 may be an external peripheral device.

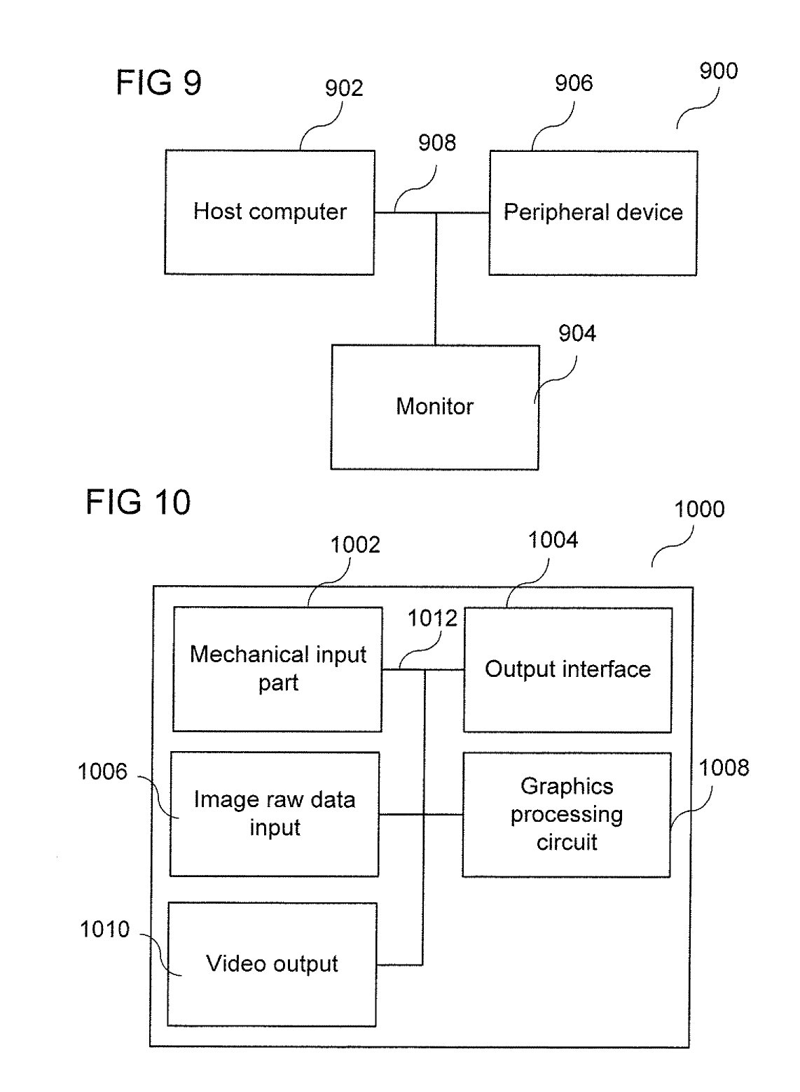

FIG. 9 shows a computing system 900 in accordance with an embodiment. The computing system 900 may include: a host computer 902, a monitor 904, and a peripheral device 906. The host computer 902, the monitor 904, and the peripheral device 906 may be connected via a connection 906 (or a plurality of separate connections), for example an electrical or optical connection, for example any kind of cable or bus. The host computer 902 may include: an input interface configured to receive an input from an external device; and an image raw data output configured to output image raw data for an image to be rendered. The peripheral device 906 may include: a mechanical input part configured to receive mechanical input from a user of the host computer; an output interface to the host computer configured to send data representing the mechanical input to the input interface of the host computer; an image raw data input configured to receive image raw data from the image raw data output of the host computer; a graphics processing circuit configured to compute pixel values of the image to be rendered based on the received image raw data; and a video output configured to output the computed pixel values to the display.

According to various embodiments, the peripheral device 906 may further include a housing (in other words: the components of the peripheral device 906 may be provided inside a housing).

According to various embodiments, the host computer 902 may further include a housing (in other words: the components of the host computer 902 may be provided inside a housing). According to various embodiments, the housing of the peripheral device 906 may be different from the housing of the host computer 902.

According to various embodiments, the mechanical input part of the peripheral device 906 may include or may be at least one of: a keyboard; a racing steering wheel; a flight controller; an arcade stick; a mouse; a joystick; a keypad; and a Razer Artemis.

According to various embodiments, the output interface of the peripheral device 906 may be configured according to at least one of: Universal Serial Bus (USB); PS/2; Advanced Technology (AT); Firewire; Thunderbolt; and Wireless Gigabit Alliance (WiGig).

According to various embodiments, the output interface of the peripheral device 906 and the image raw data input of the peripheral device 906 may be a combined interface.

According to various embodiments, the peripheral device 906 may further include an input controller configured to control the output interface of the peripheral device 906 based on the received mechanical input.

According to various embodiments, the peripheral device 906 may further include a system on a chip.

According to various embodiments, the system on a chip of the peripheral device 906 may include the input controller of the peripheral device 906.

According to various embodiments, the system on a chip of the peripheral device 906 may include any of the circuits of the peripheral device 906.

According to various embodiments, the system on a chip of the peripheral device 906 may include the graphics processing circuit of the peripheral device 906.

According to various embodiments, the peripheral device 906 may be an external peripheral device.

FIG. 10 shows a peripheral device 1000 for a computing system in accordance with an embodiment. The computing system may include: a host computer, a monitor; and the peripheral device 1000. The host computer may include: an input interface configured to receive an input from an external device; and an image raw data output configured to output image raw data for an image to be rendered. The peripheral device 1000 may include: a mechanical input part 1002 configured to receive mechanical input from a user of the host computer; an output interface 1004 to the host computer configured to send data representing the mechanical input to the input interface of the host computer; an image raw data input 1006 configured to receive image raw data from the image raw data output of the host computer; a graphics processing circuit 1008 configured to compute pixel values of the image to be rendered based on the received image raw data; and a video output 1010 configured to output the computed pixel values to the display. The mechanical input part 1002, the output interface 1004, the image raw data input 1006, the graphics processing circuit 1008, and the video output 1010 may be connected via a connection 1012 (or a plurality of separate connections), for example an electrical or optical connection, for example any kind of cable or bus.

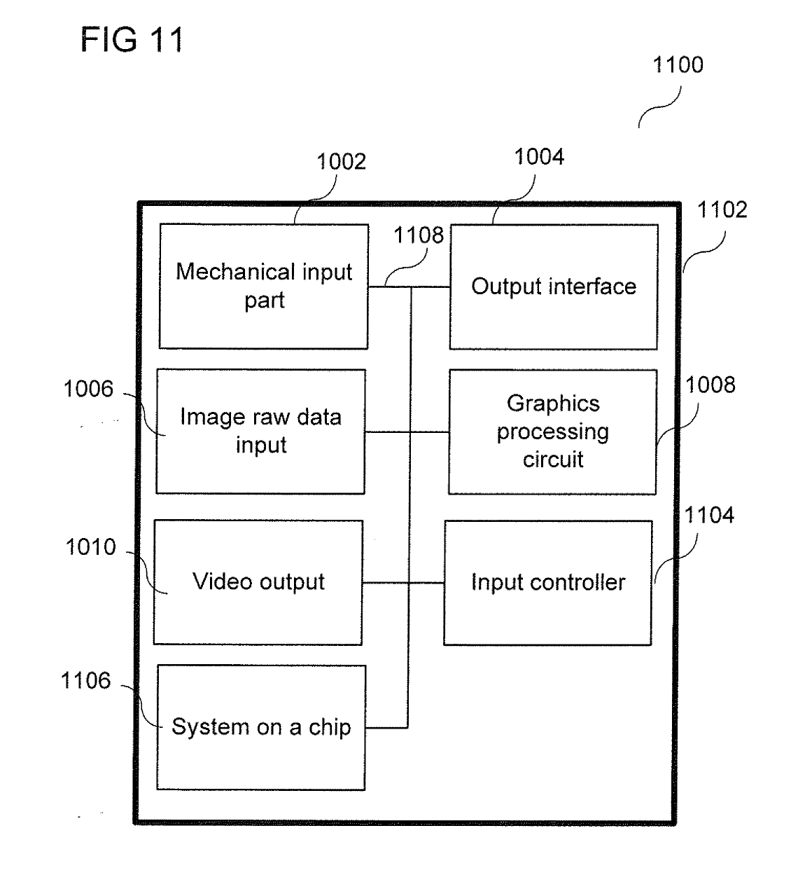

FIG. 11 shows a peripheral device 1100 for a computing system in accordance with an embodiment. The computing system may include: a host computer, a monitor; and the peripheral device 1100. The host computer may include: an input interface configured to receive an input from an external device; and an image raw data output configured to output image raw data for an image to be rendered. The peripheral device 1100 may include, similar to the peripheral device 1000 of FIG. 10, a mechanical input part 1002 configured to receive mechanical input from a user of the host computer. The peripheral device 1100 may further include, similar to the peripheral device 1000 of FIG. 10, an output interface 1004 to the host computer configured to send data representing the mechanical input to the input interface of the host computer. The peripheral device 1100 may further include, similar to the peripheral device 1000 of FIG. 10, an image raw data input 1006 configured to receive image raw data from the image raw data output of the host computer. The peripheral device 1100 may further include, similar to the peripheral device 1000 of FIG. 10, a graphics processing circuit 1008 configured to compute pixel values of the image to be rendered based on the received image raw data. The peripheral device 1100 may further include, similar to the peripheral device 1000 of FIG. 10, a video output 1010 configured to output the computed pixel values to the display. The peripheral device 1100 may further include an input controller 1104, like will be described in more detail below. The peripheral device 1100 may further include a system on a chip 1106, like will be described in more detail below. The mechanical input part 1002, the output interface 1004, the image raw data input 1006, the graphics processing circuit 1008, the video output 1010, the input controller 1104, and the system on a chip 1106 may be connected via a connection 1108 (or a plurality of separate connections), for example an electrical or optical connection, for example any kind of cable or bus.

According to various embodiments, the peripheral device 1100 may include a housing 1102, like indicated by a bold lined box in FIG. 11. In other words: the components of the peripheral device 1100 may be provided inside the housing 1102.

According to various embodiments, the host computer of the computing system may further include a housing (in other words: the components of the host computer may be provided inside a housing). According to various embodiments, the housing 1102 of the peripheral device 1100 may be different from the housing of the host computer.

According to various embodiments, the mechanical input part 1002 may include or may be at least one of: a keyboard; a racing steering wheel; a flight controller; an arcade stick; a mouse; a joystick; a keypad; and a Razer Artemis.

According to various embodiments, the output interface 1004 may be configured according to at least one of: Universal Serial Bus (USB); PS/2; Advanced Technology (AT); Firewire; Thunderbolt; and Wireless Gigabit Alliance (WiGig).

According to various embodiments, the output interface 1004 and the image raw data input 1006 may be a combined interface.

According to various embodiments, the input controller 1104 may be configured to control the output interface 1004 based on the received mechanical input.

According to various embodiments, the system on a chip 1106 may include the input controller 1104.

According to various embodiments, the system on a chip 1106 may include any of the circuits of the peripheral device 1100.

According to various embodiments, the system on a chip 1106 may include the graphics processing circuit 1108.

According to various embodiments, the peripheral device 1100 may be an external peripheral device.

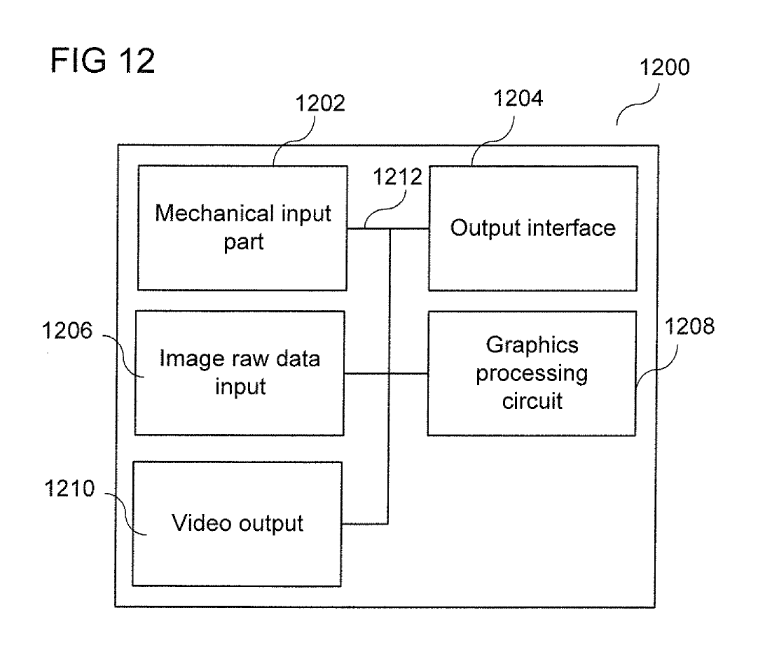

FIG. 12 shows a peripheral device 1200 for a host computer in accordance with an embodiment. The peripheral device 1200 may include: a mechanical input part 1202 configured to receive mechanical input from a user of the host computer; an output interface 1204 to the host computer configured to send data representing the mechanical input to the host computer; an image raw data input 1206 configured to receive image raw data for an image to be rendered from the host computer; a graphics processing circuit 1208 configured to compute pixel values of the image to be rendered based on the received image raw data; and a video output 1210 configured to output the computed pixel values to a display for the host computer. The mechanical input part 1202, the output interface 1204, the image raw data input 1206, the graphics processing circuit 1208, and the video output 1210 may be connected via a connection 1212 (or a plurality of separate connections), for example an electrical or optical connection, for example any kind of cable or bus.

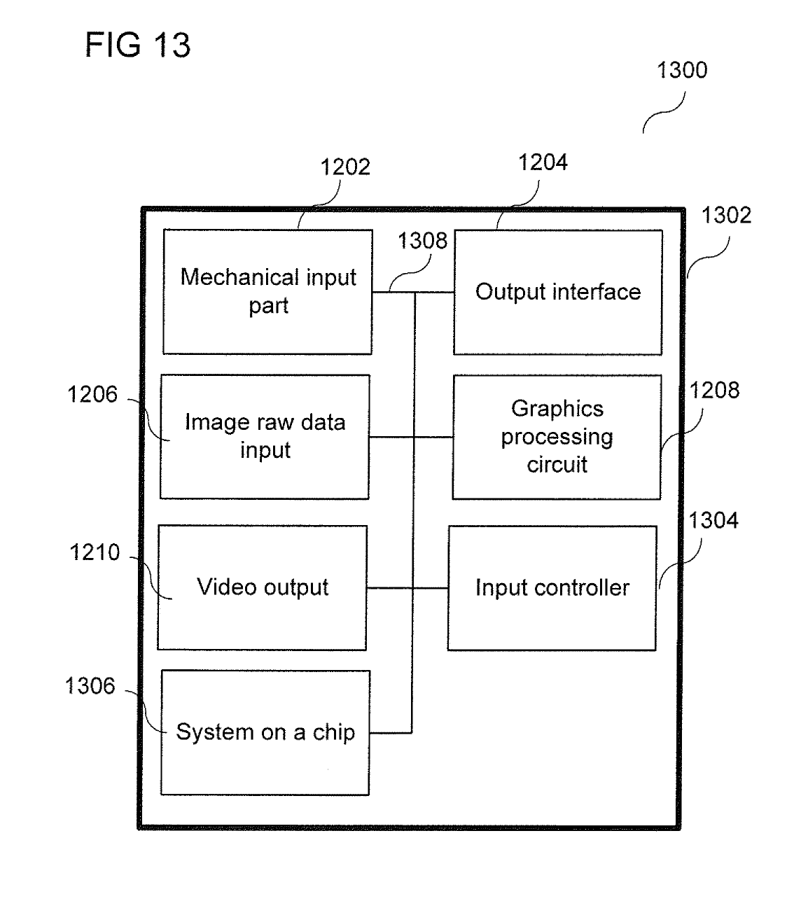

FIG. 13 shows a peripheral device 1300 for a host computer in accordance with an embodiment. The peripheral device 1300 may include, similar to the peripheral device 1200 of FIG. 12, a mechanical input part 1202 configured to receive mechanical input from a user of the host computer. The peripheral device 1300 may further include, similar to the peripheral device 1200 of FIG. 12, an output interface 1204 to the host computer configured to send data representing the mechanical input to the host computer. The peripheral device 1300 may further include, similar to the peripheral device 1200 of FIG. 12, an image raw data input 1206 configured to receive image raw data for an image to be rendered from the host computer. The peripheral device 1300 may further include, similar to the peripheral device 1200 of FIG. 12, a graphics processing circuit 1208 configured to compute pixel values of the image to be rendered based on the received image raw data. The peripheral device 1300 may further include, similar to the peripheral device 1200 of FIG. 12, a video output 1010 configured to output the computed pixel values to a display for the host computer. The peripheral device 1300 may further include an input controller 1304, like will be described in more detail below. The peripheral device 1300 may further include a system on a chip 1306, like will be described in more detail below. The mechanical input part 1202, the output interface 1204, the image raw data input 1206, the graphics processing circuit 1208, the video output 1210, the input controller 1304, and the system on a chip 1306 may be connected via a connection 1308 (or a plurality of separate connections), for example an electrical or optical connection, for example any kind of cable or bus.

According to various embodiments, the peripheral device 1300 may include a housing 1302, like indicated by a bold lined box in FIG. 13. In other words: the components of the peripheral device 1300 may be provided inside the housing 1302.

According to various embodiments, the housing 1302 may be different from a housing of the host computer.

According to various embodiments, the mechanical input part 1202 may include or may be at least one of: a keyboard; a racing steering wheel; a flight controller; an arcade stick; a mouse; a joystick; a keypad; and a Razer Artemis.

According to various embodiments, the output interface 1204 may be configured according to at least one of: Universal Serial Bus (USB); PS/2; Advanced Technology (AT); Firewire; Thunderbolt; and Wireless Gigabit Alliance (WiGig).

According to various embodiments, the output interface 1204 and the image raw data input 1206 may be a combined interface.

According to various embodiments, the input controller 1304 may be configured to control the output interface 1204 based on the received mechanical input.

According to various embodiments, the system on a chip 1306 may include the input controller 1304.

According to various embodiments, the system on a chip 1306 may include any of the circuits of the peripheral device 1300.

According to various embodiments, the system on a chip 1306 may include the graphics processing circuit 1308.

According to various embodiments, the peripheral device 1300 may be an external peripheral device.

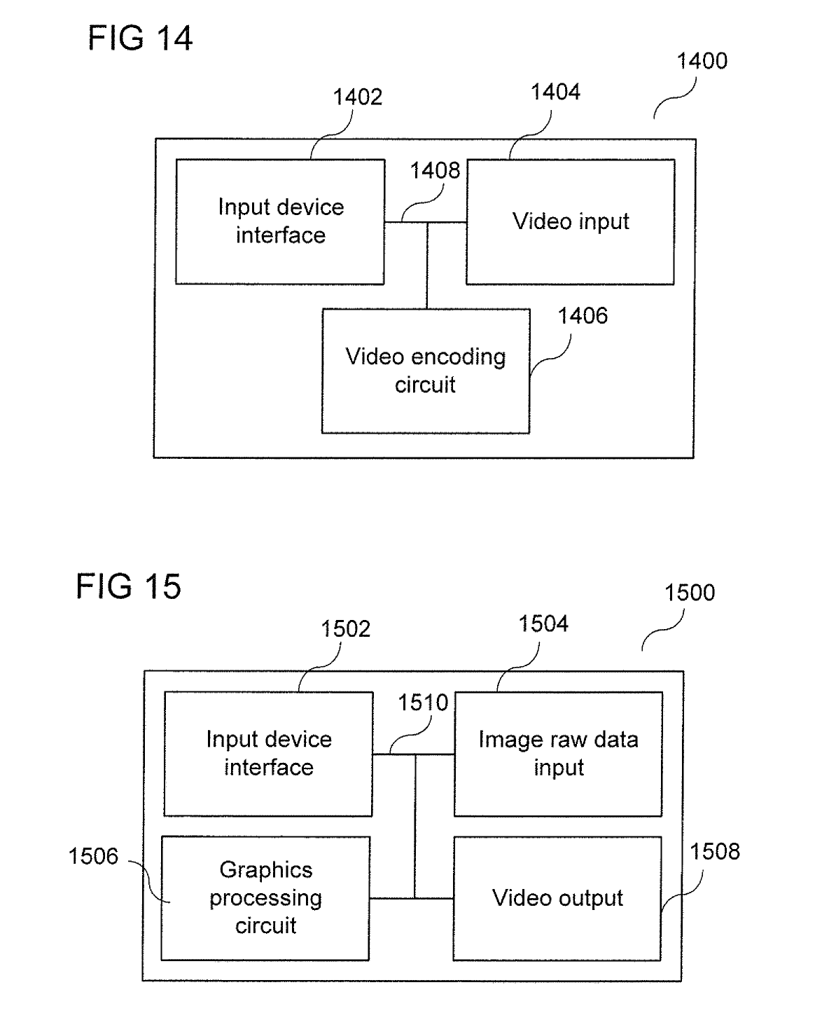

FIG. 14 shows a peripheral device 1400 for a host computer in accordance with an embodiment. The peripheral device 1400 may include: an input device interface 1402 configured to send data to and receive data from a mechanical input device for the host computer; a video input 1404 configured to receive video data from the host computer; and a video encoding circuit 1406 configured to compress the video data using a video encoder. The input device interface 1402, the video input 1404, and the video encoding circuit 1406 may be connected via a connection 1408 (or a plurality of separate connections), for example an electrical or optical connection, for example any kind of cable or bus.

FIG. 15 shows a peripheral device 1500 for a host computer in accordance with an embodiment. The peripheral device 1500 may include: an input device interface 1502 configured to send data to and receive data from a mechanical input device for the host computer; an image raw data input 1504 configured to receive image raw data for an image to be rendered from the host computer; a graphics processing circuit 1506 configured to compute pixel values of the image to be rendered based on the received image raw data; and a video output 1508 configured to output the computed pixel values to a display for the host computer. The input device interface 1502, the image raw data input 1504, the graphics processing circuit 1506, and the video output 1508 may be connected via a connection 1510 (or a plurality of separate connections), for example an electrical or optical connection, for example any kind of cable or bus.

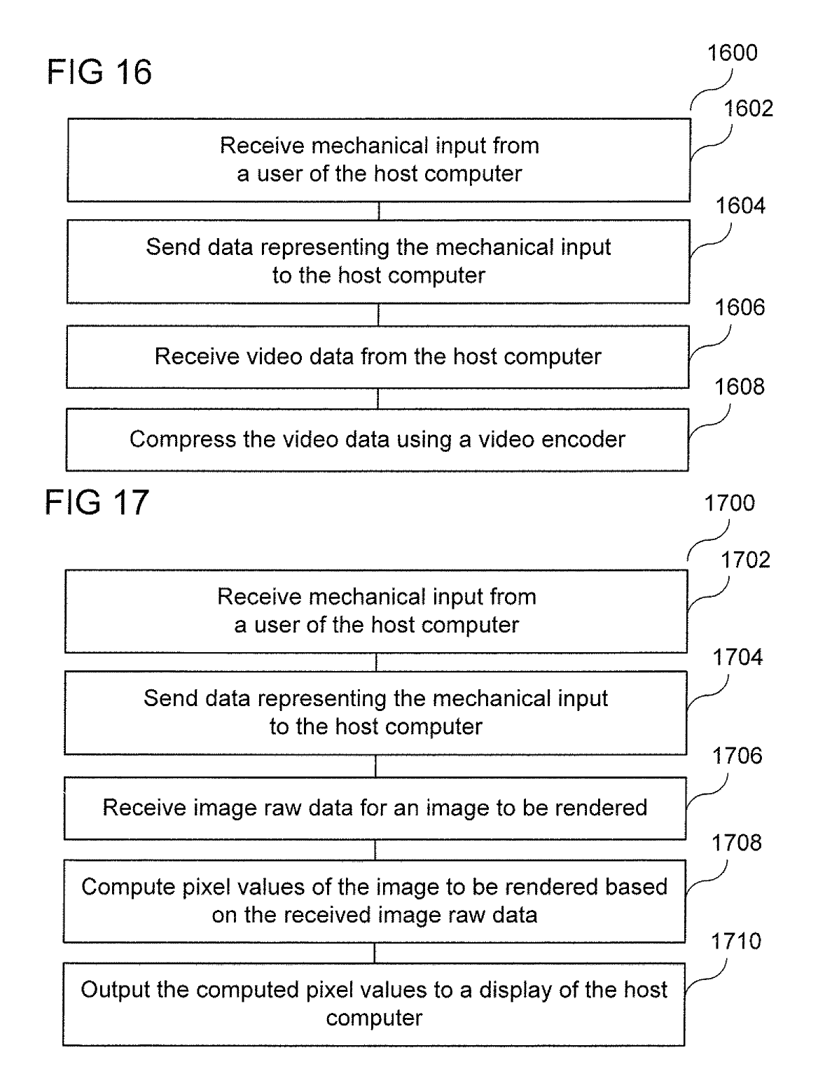

FIG. 16 shows a flow diagram 1600 illustrating a method for controlling a peripheral device for a host computer in accordance with an embodiment. In 1602, mechanical input may be received from a user of the host computer. In 1604, data representing the mechanical input may be sent to the host computer. In 1606, video data may be received from the host computer. In 1608, the video data may be compressed using a video encoder.

FIG. 17 shows a flow diagram 1700 illustrating a method for controlling a peripheral device for a host computer in accordance with an embodiment. In 1702, mechanical input may be received from a user of the host computer. In 1704, data representing the mechanical input may be sent to the host computer. In 1706, image raw data for an image to be rendered may be received from the host computer. In 1708, pixel values of the image to be rendered may be computed based on the received image raw data. In 1710, the computed pixel values may be output to a display for the host computer.

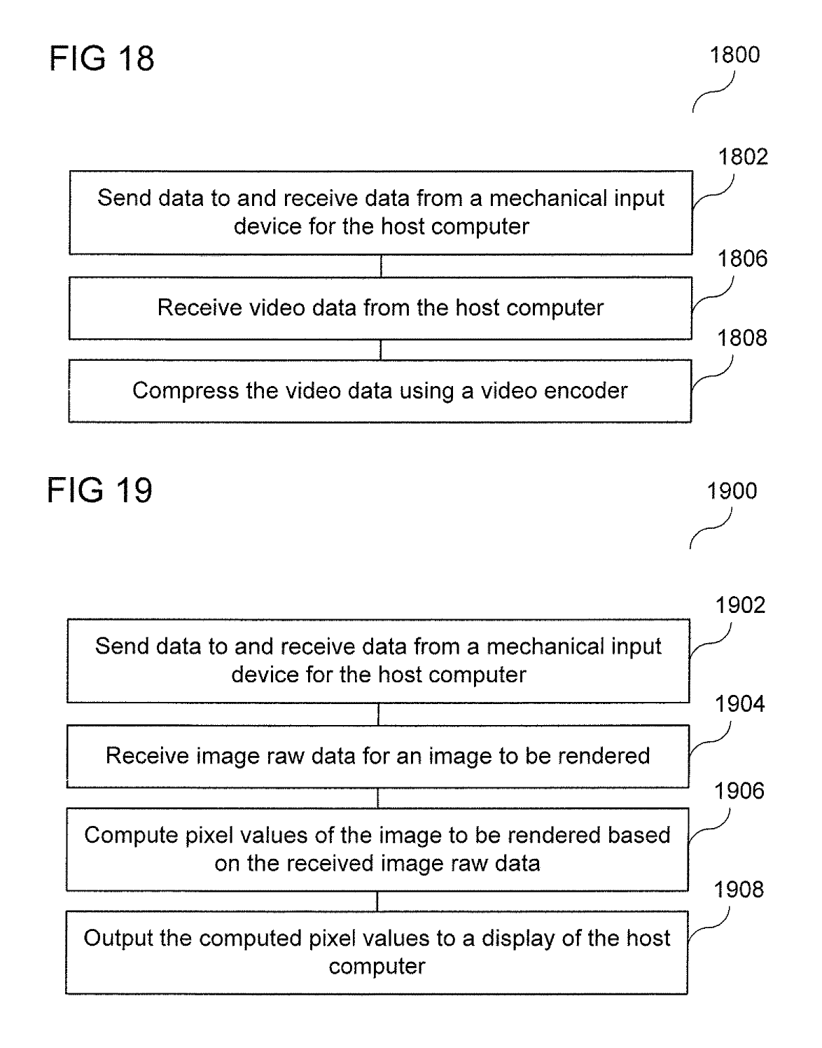

FIG. 18 shows a flow diagram 1800 illustrating a method for controlling a peripheral device for a host computer in accordance with an embodiment. In 1802, data may be sent to and received from a mechanical input device for the host computer. In 1804, video data may be received from the host computer. In 1806, the video data may be compressed using a video encoder.

FIG. 19 shows a flow diagram 1900 illustrating a method for controlling a peripheral device for a host computer in accordance with an embodiment. In 1902, data may be sent to and received from a mechanical input device for the host computer. In 1904, image raw data for an image to be rendered may be received from the host computer. In 1906, pixel values of the image to be rendered may be computed based on the received image raw data. In 1908, the computed pixel values may be outputted to a display for the host computer.

According to various embodiments, a keyboard may be provided which may incorporate video input, output, recording and/or playback capabilities in addition to the normal keyboard functionality. The keyboard may incorporate a System-on-Chip device with a dedicated embedded operating system and digital signal processing capabilities, so as to operate independently of the host operating system. The keyboard may also incorporate storage capacity sufficient to record some number of minutes (for example 30) of video, for example for instant review. Further, the keyboard may include the computational capabilities for encoding and saving video files which may be shared with the host over the local network, or video the peripheral connection (e.g. USB). New buttons or interaction methods may be included to serve as transport controls such as play, pause, rewind, and fast forward, for example.

According to various embodiments, the user (for example gamer) may connect his PC to his keyboard, instead of his display, and then may connect the display to the keyboard as well. The keyboard then may record video and may save the last N number of minutes, where N may be limited for example by the storage remaining in the keyboard. The user may for example choose to: Pause the video to view some on-screen event more carefully; incrementally advance the video to view an on-screen event in less than real-time; fast forward video to return to the “live” video being transmitted by the host; rewind the video, up to the limit of the live video buffer, to review past events; and save the video buffer to a file to be reviewed and/or shared at a later time.

According to various embodiments, a SoC supporting networking capabilities may be provided, and the SoC may transmit (or upload) video to a remote system autonomously and independent of the host operating system (OS) to which the device is attached.

According to various embodiments, devices and methods may be provided for recording and “time shifting” video in a manner similar to DVR (digital video recorder) devices, completely within the keyboard itself, obviating a separate device or performance-hindering software to be running on the host. The keyboard's included SoC device may run its own operating system, independent of the host OS for which it is attached to via USB and video connection, and this dedicated operating system may record, encode and transmit video in a way that is transparent to the host operating system and the applications which run on it.

This may mean that gamers may enjoy the benefits of time-shifting their video, without impairing their game's performance.

According to various embodiments, device and methods may be provided that incorporate DVR functionality which may be similar to functionality found in digital media end user equipment, or in software which may burden the host OS and may impair the performance of games.

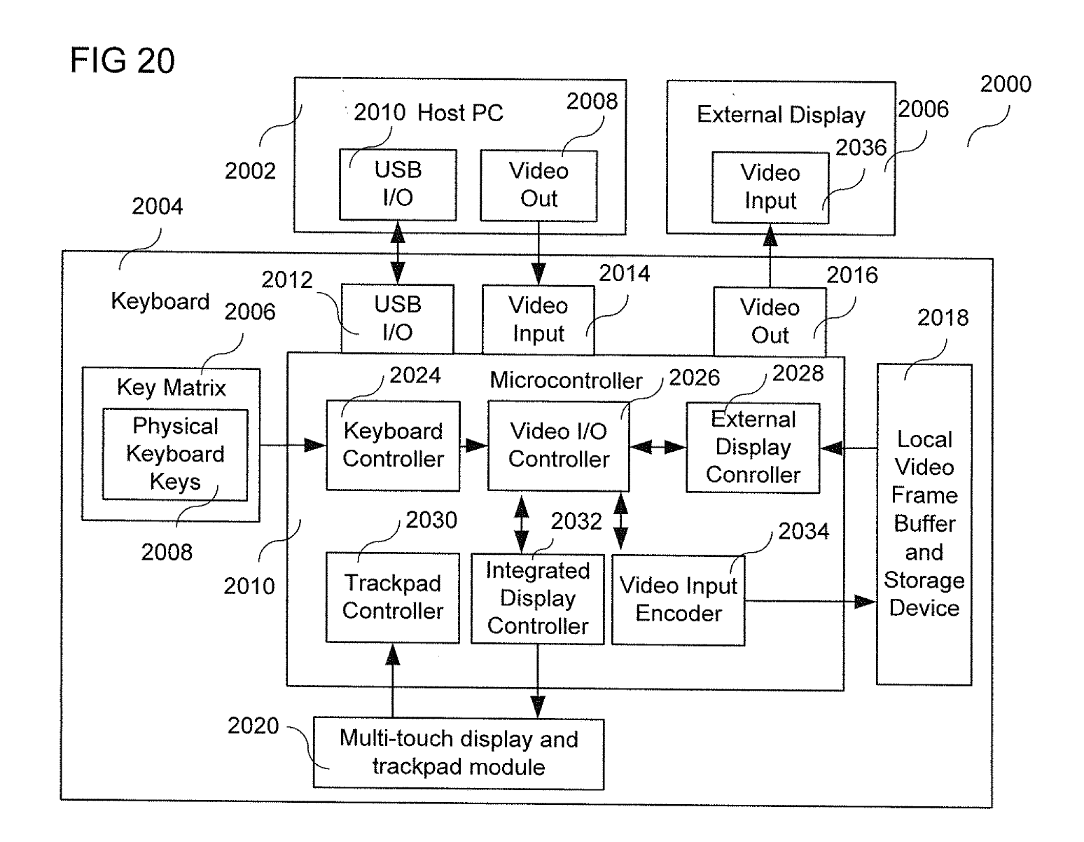

FIG. 20 shows a computing system 2000 in accordance with an embodiment. The computing system may include a host computer 2002 (for example a host personal computer (PC)), a keyboard 2004, and an external display 2006. The host computer 2002 may include a USB I/O (universal serial bus input/output interface) 2010 and a video output 2008. The video output 2008 may usually be connected to a monitor (in other words: display; in other words: external display). According to various embodiments, the video output 2008 may be connected to a video input 2014 of the keyboard 2004. The keyboard 2004 may include a key matrix 2006, which may include physical keyboard keys 2008. The key matrix 2006 may provide information about which key is pressed to a keyboard controller 2024 in the microcontroller 2010. The keyboard 2020 may further include a multi-touch display and trackpad module 2020, which may be controlled by a trackpad controller 2030 in the microcontroller 2010 and an integrated display controller 2032 in the microcontroller. The microcontroller 2010 may further include a video input/output (I/O) controller 2026, which may exchange information with the integrated display controller 203 and a video input encoder 2023. The video input/output controller 2026 may further exchange information with an external display controller 2028 in the microcontroller 2010. The video input encoder 2034 may transmit data to a local video frame buffer and storage device 2018 in the keyboard 2004. The local video frame buffer and storage device 2018 may transmit data to the external display controller 2028. A video output 2016 in the keyboard 2004 may transmit video data to a video input 2036 in the external display 2006. The keyboard 2004 may also be referred to as video recording keyboard. As described above, the video recording keyboard may include a video input 2014, which may go into a video I/O controller (VIOC) 2026. This VIOC 2026 may control other devices, enabling video to be displayed on the integrated display 2020, the external display 2006, or encoded (and recorded (in other words: stored)) onto the integrated storage device 2018.

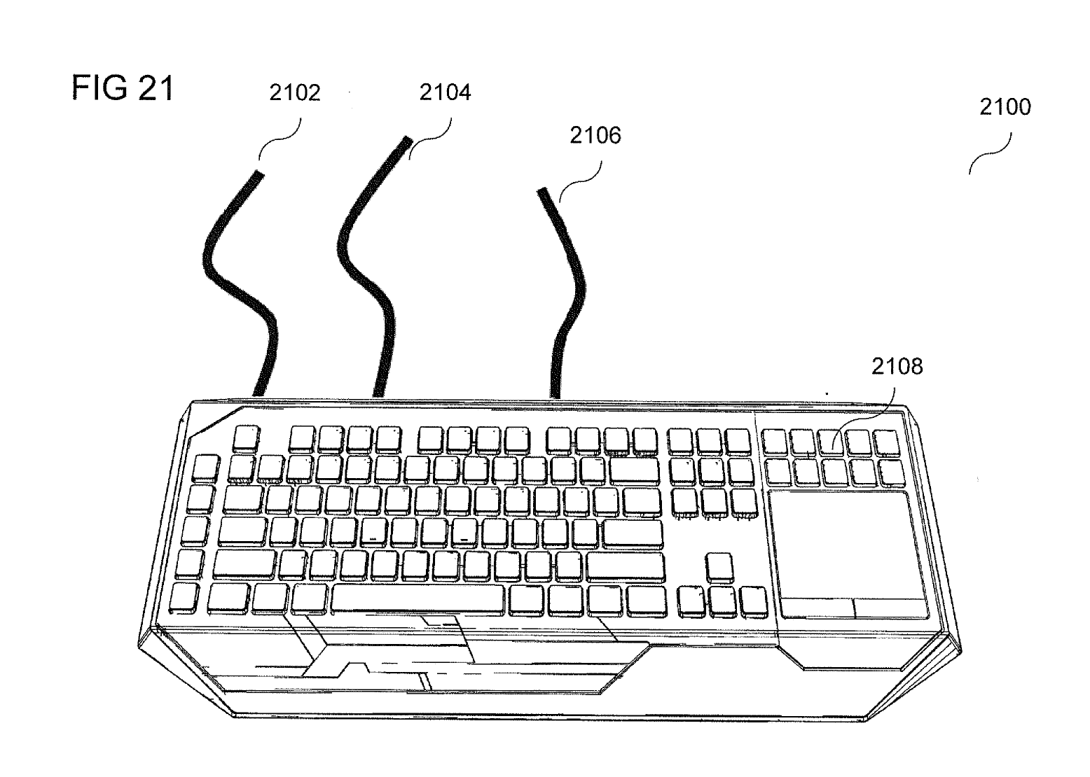

FIG. 21 shows a peripheral device 2100 (which may also be referred to as video recording keyboard) in accordance with an embodiment. A video input 2102, a video output 2104 and a USB connection 2106 may be provided as interfaces to the video recording keyboard 2100. Transport controls 2108 may provide control elements for controlling the video recording function, for example for starting recording, stopping recording, starting playback (in other words: re-play), stopping playback, fast forward, fast backward, or pausing. Inside the keyboard 2100, there may be provided a hard drive and a SoC configured to encode video and buffer the incoming video, and to pass video through to the output 2104.

While the invention has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

1-20. (canceled)

21. A keyboard for a host computer, the keyboard having video recording capabilities, and the keyboard comprising:
a mechanical input part configured to receive mechanical input from a user of the host computer;
an output interface to the host computer configured to send data representing the mechanical input to the host computer;
a video input configured to receive video data from the host computer; and
a video encoding circuit configured to compress the video data using a video encoder; and
a video output configured to output at least one of the received video data and the compressed video data.

22. The keyboard of claim 21, further comprising:
a housing.

23. The keyboard of claim 22,
wherein the housing of the keyboard is different from a housing of the host computer.

24. The keyboard of claim 21,
wherein the output interface is configured according to at least one of:
Universal Serial Bus;
PS/2;
Advanced Technology;
Firewire;
Thunderbolt; and
Wireless Gigabit Alliance.

25. The keyboard of claim 21,
wherein the output interface and the video input are a combined interface.

26. The keyboard of claim 21,
further configured to receive data for controlling the video encoding circuit from the host computer.

27. The keyboard of claim 26,
wherein the data for controlling the video encoding circuit comprises information indicating when processing of the video encoding circuit is to be started.

28. The keyboard of claim 21, further comprising:
a video recording circuit configured to record at least one of the received video data and the compressed video data.

29. The keyboard of claim 21, further comprising:
a video sending circuit configured to send at least one of the received video data and the compressed video data.

30. The keyboard of claim 21, further comprising:
a video playing circuit configured to play a video.

31. The keyboard of claim 21, further comprising:
a display.

32. The keyboard of claim 31,
wherein the display is configured to display the video data.

33. The keyboard of claim 32,
wherein the display comprises a touch sensitive display.

34. The keyboard of claim 33,
wherein the touch sensitive display is configured to provide control elements for controlling the video encoding circuit.

35. The keyboard of claim 21, further comprising:
a digital media recording chip.

36. The keyboard of claim 21, further comprising:
a video processing controlling element configured to receive a user input for controlling of processing of the video encoding circuit.

37. The keyboard of claim 36,
wherein the output interface is further configured to send data representing a mechanical input command to the host computer based on the received user input of the video processing controlling element.

38. The keyboard of claim 37,
wherein the data representing a mechanical input command based on the received user input of the video processing controlling element is data representing an instruction for pausing an application of the host computer.

39. The keyboard of claim 21,
wherein the video output is configured to output video data based on recorded video data.

40. The keyboard of claim 21,
wherein the video output is configured to display the video data on a monitor.
